(19) United States
(12) Patent Application Publication
(10) Pub. No.: US 2007/0211682 A1
(43) Pub. Date: Sep. 13, 2007

(54) On Packet Aggregation and Header Compression Mechanisms for Improving VoIP Quality in Mesh Networks

(75) Inventors: KyungTae Kim, West Windsor, NJ (US); Rauf Izmailov, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/683,641

(22) Filed: Mar. 8, 2007

Related U.S. Application Data
(60) Provisional application No. 60/743,441, filed on Mar. 9, 2006.

(51) Int. Cl. H04Q 7/24

(52) U.S. Cl. 370/338

(57) ABSTRACT

An improved aggregation scheme for wireless multi-hop mesh networks is disclosed. An aggregator at each node operates to merge VoIP packets at an ingress/source node with a forced delay, but at an intermediate node aggregated packets are either sent directly to their destination or to the next hop without deaggregation. A novel compression mechanism for compressing and decompressing the aggregated packets is also disclosed.

### CROSS REFERENCE TO RELATED APPLICATIONS

This non-provisional application claims the benefit of U.S. Provisional Application Ser. No. 60/743,441 entitled “On Packet Aggregation Mechanisms For Improving VoIP Quality In Mesh Networks,” filed Mar. 9, 2006, the content of which is hereby incorporated by reference herein.

### FIELD OF THE INVENTION

The present invention relates generally to communication networks, and more particularly, to an improved packet aggregation and header compression scheme for improving performance in wireless multi-hop networks.

### BACKGROUND OF THE INVENTION

Recent times have seen a tremendous proliferation of VoIP services for both residential and corporate applications. For example, FCC data indicates that there were as many as seven million residential VoIP lines in use by the end of 2005. This number is expected to increase significantly over the next several years. In the corporate sector, the percentage of VoIP lines is anticipated to increase by as much as 44% by 2008. In addition, services such as “Skype™” that provide free internet calls, have recorded more than 10 billion minutes of call time in the first year of operation. The cost savings achieved by VoIP by using existing data infrastructures along with easy deployment benefits are the main reasons driving the steady growth of VoIP. At the same time, VoIP over wireless LAN (WLAN) has the potential of becoming an important application due to the ubiquity of the WLAN in homes and offices. With the advent of dual cell phone handset with WiFi capabilities and softphones over PDAs, carrying voice over the WLAN is gaining a significant importance. Once VoIP over WLAN becomes widespread, most cell phone or WiFi handset owners will migrate to using VoIP over WLAN inside the administrative boundaries of the enterprise buildings, campuses, public places such as airports or even in WLAN equipped homes.

Providing VoIP users with true mobile phone services having the freedom of roaming requires wide area wireless coverage, and IEEE 802.11-based multi-hop wireless mesh networks have been considered a practical solution for wide area coverage. The benefits of a mesh network compared to wired LAN connecting WiFi access points are: i) ease of deployment and expansion; ii) better coverage; iii) resilience to node failure; iv) reduced cost of maintenance. Such a mesh network has the potential of creating an enterprise-scale or community-scale wireless backbone supporting multiple users while driving these users from using fixed phones to wireless VoIP phones.

However, supporting delay sensitive real-time applications such as VoIP over wireless mesh networks is challenging. Although convenient and cheap, voice service over WLAN faces a number of technical problems: a) providing QoS sensitive VoIP traffic in presence of best effort TCP data traffic; b) packet loss due to channel interference by using unlicensed bands (2.4 GHz, 5 GHz); c) high overhead of the protocol stack—802.11/IP/UDP/RTP for each VoIP packet with 20 bytes payload. The above problems become even more severe when supporting VoIP over multi-hop mesh networks. In a multi-hop wireless network operating on a single channel, the UDP throughput decreases with number of hops for properly spaced nodes and can be shown to be between ¼ and 1/7 that of single hop capacity. This phenomenon of self interference is produced by different packets of the same flow competing for medium access at different nodes. When all nodes are within interference range, the UDP throughput in a linear topology can degrade to 1/n, where n is the number of hops.

A VoIP system consists of an encoder-decoder pair and an IP transport network. The choice of vocoder is important because it has to fit the particularities of the transport network (loss and delay). One of the popular voice encoders is G.729, which uses 10 ms or 20 ms frames. It is used by some available 802.11 VoIP phones (such as the Zyxel® Prestige, Senao® S7800H, and by other wired VoIP phones as well). The Zyxel® Prestige for example, sends 50 packets per second, of 20 bytes each.

Since most vocoders use samples of 10-100 ms, a mesh node is expected to get a large volume of small packet traffic. However, 802.11 networks incur a high overhead to transfer one packet, thus such small sized packets reduce network utilization and efficiency. The problem with small payloads is that most of the time spent by the 802.11 MAC is for sending headers and acknowledgments, waiting for the separation of DIFS and SIFS, and contending for the medium. For example, in order to send a 20 byte VoIP payload, a 60 byte packet is assembled from 20 bytes for the IP header, 12 bytes for the RTP header, and 8 bytes for the UDP header. This takes 43.6 μsec to send at 11 Mbps, but the MAC and physical headers trailers, inter-frame periods and ACK need a total of 444 μsec. This does not even consider the amount of contention, which can average 310 μsec. Sending a 20 byte payload takes 800 μsec at 11 Mbps, yielding approximately 1250 packets per second. For a G.729 vocoder, only 12 calls can be supported per hop. At 2 Mbps, a similar computation shows that only 8 calls can be supported per hop.

One technique that can be employed for reducing this overhead is packet aggregation. The basic premise behind packet aggregation is to combine several small packets at an aggregator in the ingress nodes in the mesh network, and to forward the combined packets with a single IP, MAC and PHY header through the network. A common problem with packet aggregation is the increase in packet delay, thereby reducing its applicability for VoIP services. However, if the network is lightly loaded, the packet aggregation techniques do not have to be used for improving network performance. Under heavy load, small sized packets would experience heavy contention leading to retransmission and dropped packets. The packets then spend the largest part of the network delay in the queues at the intermediate nodes in the mesh network. The higher the contention to access wireless media, the larger the network delay. These small packets waiting for media access are candidates for packet aggregation. Thus, packet aggregation during heavy network load does not need to introduce a forced delay to combine packets.

Another technique for reducing overhead is packet compression. A known expedient is referred to as Robust Header Compression (ROHC). This mechanism reconstructs IP/UDP/RTP headers in the presence of packet losses and errors, and makes use of intra-packet and inter-packet redundancy. This requires the status of a compressor and decompressor at respective transmitting and receiving nodes to be synchronized. Existing solutions for providing such synchronization either sacrifice the header compression ratio by sending uncompressed packets periodically or use feedback information. This, however, provides a high error propagation rate and can increase the roundtrip time of communications on a wireless link.

### SUMMARY OF THE INVENTION

In accordance with a first aspect of the invention, in a mesh network that comprises a plurality of nodes, where each node has a client interface and a backhaul interface for communicating between the nodes, a method is provided for aggregating a plurality of packets. The method comprises: at an ingress node that receives packets from at least one client, introducing a forced delay prior to aggregating packets at the ingress node; and at least one intermediate node communicating with the ingress node, forwarding aggregated packets received from the ingress node to a destination node. A parameter for aggregating a minimum number of packets is set at the ingress node, and a timer is set for specifying a maximum time to wait to aggregate the packets at the ingress node. Upon expiration of the timer, the method aggregates packets from all flows to the ingress node having the same destination node until a size of the aggregated packets reaches the maximum transmission unit (MTU), and then sends the aggregated packets to the destination node via the at least one intermediate node. Alternatively, upon expiration of the timer, the method aggregates packets from all flows to the ingress node having a same next hop intermediate node until a size of the aggregated packets reaches the MTU, and then sends the aggregated packets to the next hop intermediate node.

In accordance with another aspect of the invention, a method is provided for compressing and decompressing packet headers of a plurality of packets in a mesh network including a plurality of nodes is provided. The method comprises the steps of: aggregating a plurality of packets in a flow into aggregated packets at a first node in the mesh network; extracting the uncompressed header of a first packet in the flow; compressing the aggregated packets at the first node; deaggregating the aggregated packets at a second node in the mesh network; and decompressing the aggregated packets with the uncompressed header of the first packet in the flow at a second node in the mesh network.

These and other advantages of the invention will be apparent to those of ordinary skill in the art by reference to the following detailed description and the accompanying drawings.

### BRIEF DESCRIPTION OF THE DRAWINGS

FIG. 1 is a schematic of an exemplary wireless mesh network;

FIG. 2 is a schematic of an illustrative node in the mesh network of FIG. 1;

FIG. 3 is a schematic of an illustrative router architecture and aggregator at a node;

FIG. 4 is a schematic of a plurality of nodes for describing an example of accretion aggregation of packets in accordance with an aspect of the invention;

FIG. 5 is a flow diagram of an accretion aggregation methodology in accordance with an aspect of the invention;

FIG. 6 is a schematic of an illustrative methodology for zero-length header compression (ZLHC) in accordance with an aspect of the invention;

FIG. 7 is a schematic of ZLHC in a mesh network using hop-by-hop aggregation; and

FIG. 8 is a schematic of ZLHC in a mesh network using accretion aggregation.

### DETAILED DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

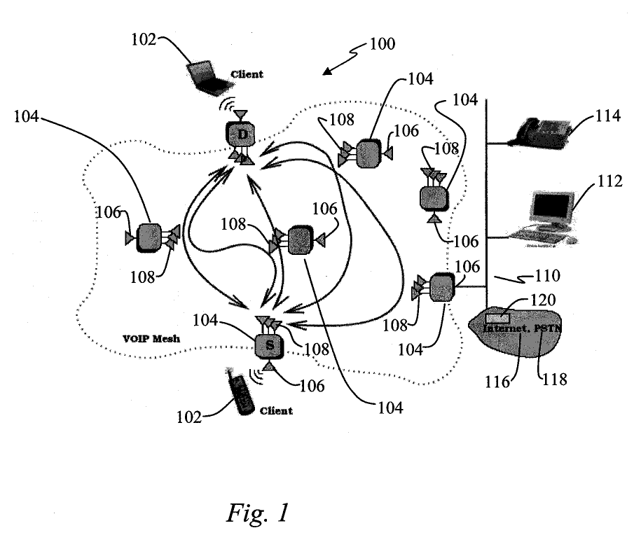

FIG. 1 is a schematic of an exemplary wireless mesh network 100 comprising a plurality of client devices 102 which can be VoIP wireless phones, laptop computers, or any other wireless network access device (collectively “wireless network access devices”). A plurality of mesh nodes 104 provide communication paths throughout network the network 100. Each mesh node 104 has at least two wireless interfaces, a first interface 106 for communicating with the clients 102 and a second interface 108 for a backhaul connection among the nodes 104. A node 104 may provide connectivity to a local intranet 110 containing a plurality of network access devices (e.g., computer 112 and VoIP phone 114), or to the Internet 116 or a PSTN 118 via a gateway 120.

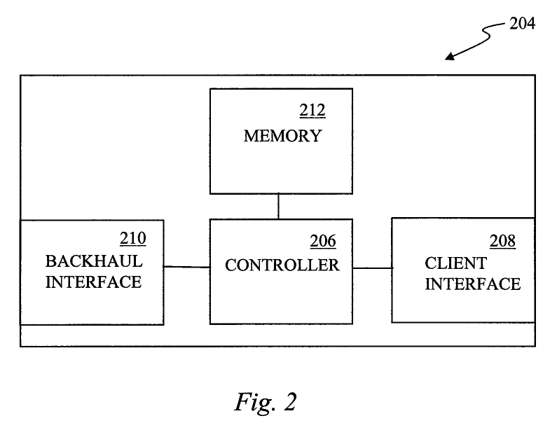

FIG. 2 is a schematic of an illustrative node 204 that comprises a controller 206 that couples to a first 802.11 wireless interface 208 for communicating with client devices, and a second 802.11 wireless interface 210 for establishing a backhaul connection. The controller 206 is coupled to memory 212, which may include EPROM, EEPROM, flash memory, magnetic disks and the like. Although only 2 interfaces are shown, additional interfaces may be employed at the node 204. Each mesh node implements routing functions to forward packets throughout the network and aggregation/deaggregation as described in greater detail below.

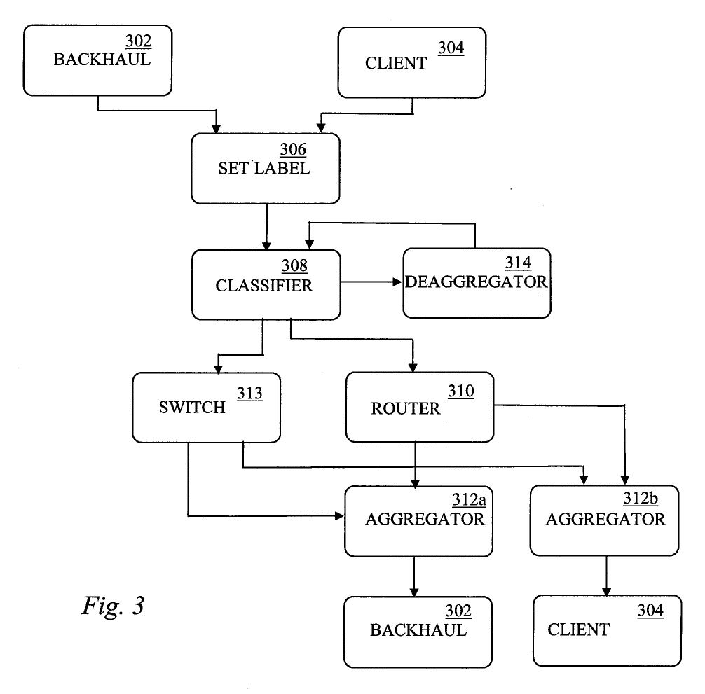

An illustrative router architecture is depicted in FIG. 3. In this expedient, voice packets use label based forwarding and routing, while other traffic uses regular routing. When a packet is received from one of the backhaul interfaces 302 or client interfaces 304, it may get labeled at 306 if it is a voice packet which needs to be routed over the mesh network. A classifier 308 decides whether a packet has to be routed (best effort traffic, signaling) at 310, or label routed for voice. Packets which are classified as voice packets may be aggregated by an aggregator module 312a, 312b coupled to the backhaul or client interface 302, 304. A switch 313 couples the classifier 308 to the appropriate aggregation module 312 for each of interfaces 302, 304. Aggregated packets that are received at the node may be deaggregated at 314 and then provided to the classifier 308, which may then instruct these packets to join another aggregation path. The aggregator is implemented by a software module that may be provided on any machine readable medium. Alternatively, the aggregator may be implemented by a firmware module or hardware/software combination.

A first aggregation algorithm is referred to as “end-to-end aggregation.” In the end-to-end aggregation algorithm, the aggregator at the ingress node combines small packets that are destined for the same destination. The intermediate nodes in the path forward the aggregated packets without any deaggregation. This aggregation methodology reduces computational complexity at the intermediate nodes, and consequently reduces hardware resource requirements at the mesh routers. The following parameters are employed in Algorithm 1: minPackets—number of packets to be aggregated, maxTime—maximum waiting time to aggregate, P—first packet queued at node, P′—number of packets with the same destination as P, P″—number of packets with the same next hop as P, A—aggregation packet, MTU—maximum transmission unit.

Algorithm 1 End-to-End Aggregation

```
{Ingress and Egress node aggregation}
repeat
  if P and P′ > minPackets then
    while A < MTU do
      aggregate all packets from P′;
    end while
  else if P and timer(maxTime) is expired then
    while A < MTU do
      aggregate all packets from P′;
    end while
  end if
  send A to destination node directly and reset timer(maxTime)
until Ingress node has VoIP packets
```

The next type of aggregation algorithm is referred to as “hop-by-hop.” The hop-by-hop algorithm requires the greatest computational complexity and hardware resources since all packets are aggregated at one node and then deaggregated at the next intermediated node until the packets arrive at their destination as shown in the following Algorithm:

Algorithm 2 Hop-by-Hop Aggregation

```
{All nodes are included in aggregation procedure throughout path}
repeat
  if P and P″ > minPackets then
    while A < MTU do
      aggregate all packets from P″;
    end while
  else if P and timer(maxTime) is expired then
    while A < MTU do
      aggregate all packets from P″;
    end while
  end if
  send A to next hop directly and reset timer(maxTime)
until VoIP packets
```

In accordance with an aspect of the invention, there is provided an “accretion aggregation algorithm” that maximizes the benefits of both the “end-to-end” and “hop-by-hop” algorithms described above. In accretion aggregation, the aggregator at each mesh node merges VoIP packets at a mesh node that functions as a “ingress/source” node for VoIP packets by introducing a forced delay for those packets, but forwards an aggregated packet that has reached the size of the maximum transmission unit (MTU) directly to the destination, thereby relieving the hardware requirements at all intermediate nodes in the mesh. The introduction of a forced delay at the ingress node increases packet latency somewhat as the ingress node is forced to wait to acquire the VoIP packets in the same flow. However, this reduces the queuing delay caused by network contention due to a reduction in the overall number of small sized VoIP packets. The greater the forced waiting time (maxTime) at the ingress node to aggregate more packets causes a longer network delay, and this may degrade voice quality. However, there is a tradeoff between increasing network delay and reducing protocol overhead. If the delay budget for the packets is known, the waiting time (total budget−transmit time) at the ingress/source node can be used to set the initial forced delay. The following is an accretion algorithm in accordance with an aspect of the invention:

Algorithm 3 Accretion Aggregation

```
{Ingress w/forced delay and intermediate nodes using natural MAC}
repeat
  if P and P′ > minPackets then
    while P′ and A < MTU do
      aggregate all packet from P′;
    end while
    if A > MTU then
      send A to the destination directly and reset timer (maxTime)
      continue;
    end if
    while P″ and A < MTU do
      aggregate all packets from P″;
    end while
  else if P″ and timer(maxTime) is expired then
    while A < MTU do
      aggregate all packets from P″;
      send A to the next hop and reset timer(maxTime)
    end while
  end if
until VoIP packets
```

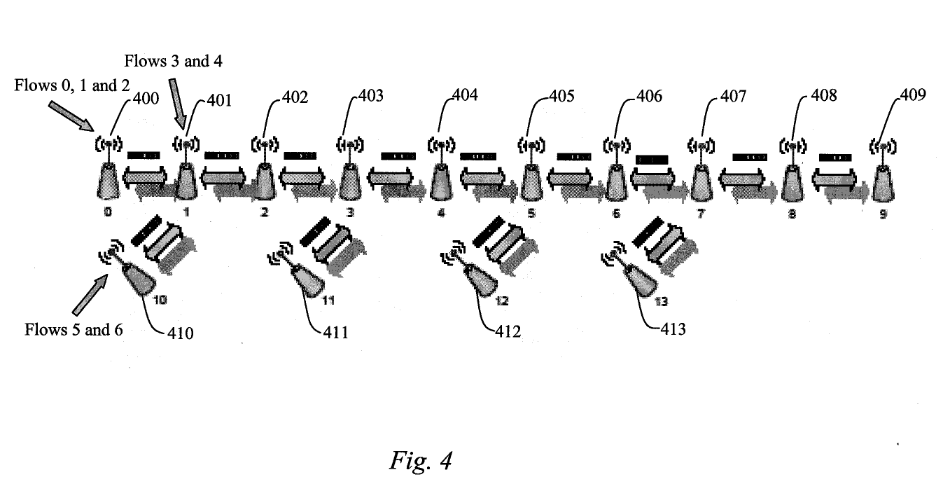

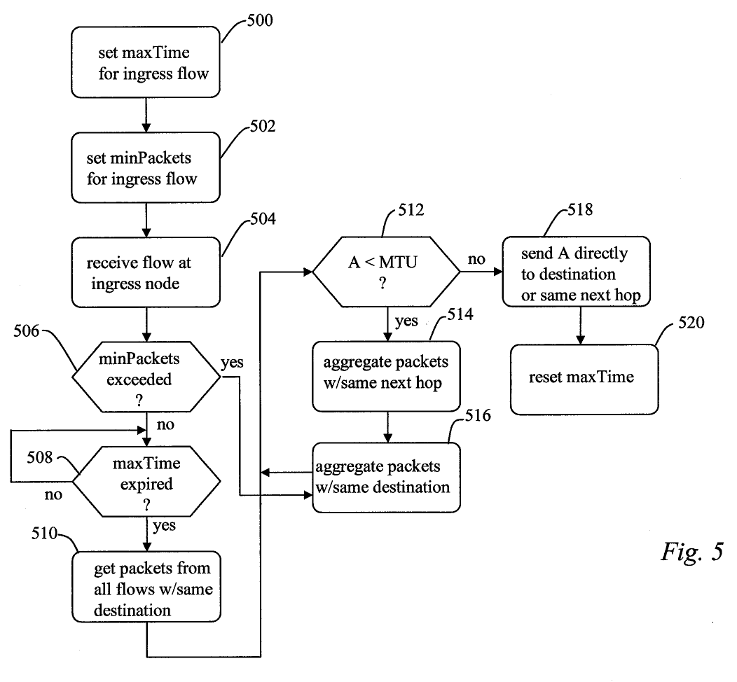

Referring now to FIG. 4, there are depicted a plurality of nodes 400, 401, . . . 413. It is assumed that node 409 is a gateway to provide Internet access and nodes 400, 401, 411 and 412 have VoIP calls with node 409. Node 400 has three calls as an ingress node—flow 0, flow 1 and flow 2. Node 401 has two calls, flow 3 and flow 4. Node 410 has two calls, flow 5 and flow 6. Each mesh node has two interfaces as described in the foregoing, one for the clients and one for the backhaul. With reference to the flow diagram in FIG. 5, the aggregator in each node utilizes the aggregation parameter minPackets at 500, the number of packets in the same flow that enters the network, and maxTime at 502, the maximum waiting time to initiate the aggregation procedure. In the case of node 401, a minPackets value of “3” is applied to flows 3 and 4 which results in a 40 millisecond delay for each flow. The flows 3 and 4 are received at node 401 at step 504. If the minPackets threshold is not exceeded at step 506, which means that neither of flows 3 or 4 have three packets in the flow queue, then control jumps to step 508. If the minPackets threshold is reached, control jumps to step 516, where the node 401 aggregates all packets P′ with the same destination. If the maxTime has expired at step 508, then at step 510 the node 401 implements the aggregation procedure and gets all packets from all flows having the same destination. In the example shown in FIG. 4, this is node 409. If the maxTime has not expired, then do nothing. At step 512, node 401 checks whether the number of aggregated packets is less than the MTU. If the number of packets is less than the MTU, the aggregator in node 401 aggregates packets P″ with the same next hop (i.e., node 402) at step 514. When the aggregated packet A reaches the MTU at step 512, node 401 collects the packets from all flows that satisfy the MTU and sends the aggregated packet A to the next hop or final destination directly at step 518. The maxTime is then reset at step 520.

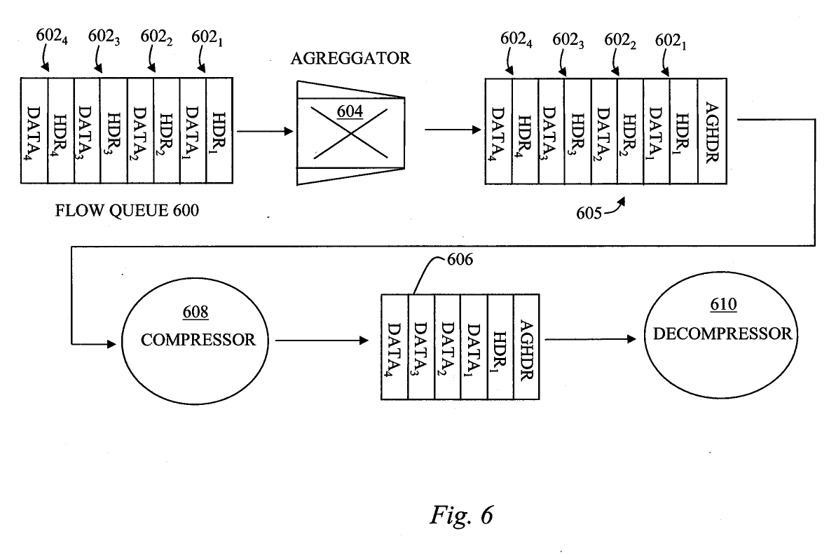

Referring now to FIG. 6, another aspect of the invention utilizes what the inventors refer to as Zero-Length Header Compression (ZLHC). ZLHC exploits packet aggregation by eliminating the need to compress the headers of multiple packets in the same flow. In this regard, FIG. 6 depicts a flow queue 600 comprising 4 packets in the same flow 602₁, 602₂, 602₃ and 602₄. Each packet 602₁-602₄ includes a respective header HDR and data payload Data₁-Data₄. The packets in the flow queue 600 are aggregated at aggregator 604 at one of the intermediate nodes in a mesh network as described in the foregoing. The aggregated packets are represented by the reference numeral 605 and include each packet header (HDR₁-HDR₄) and an aggregated packet header (AGHDR). These aggregated packets 605 are applied to compressor 608 which reduce the headers to have only the first header for packet 602₁. The aggregated packets 605 after header compression are represented by the reference numeral 606. At the receiving node where the aggregated packets are deaggregated, the aggregated packets with header compression 606 are subsequently decompressed by decompressor 610. In accordance with an aspect of the invention, only one uncompressed header (HDR₁) is transferred from the compressor 608 to the decompressor 610 for the same voice flow of packets in the aggregated packets 606. Upon receiving the aggregated packets 606, the decompressor has the header HDR₁ of the first packet 602₁ intact, and only the data payloads for packets 602₂, 602₃ and 602₄. Assuming the first packet 602₁ has sequence number 100, the decompressor will know the sequence numbers 101-103 for the other packets 602₂, 602₃ and 602₄. This methodology does not require any feedback from the decompressor to the compressor.

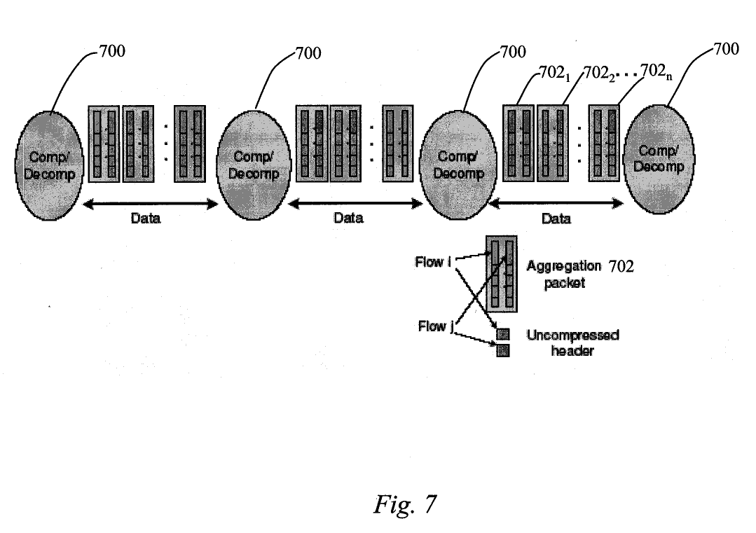

FIG. 7 is a flow diagram of ZLHC with hop-by-hop aggregation as described above at each node 700 in a mesh network. Using hop-by-hop aggregation, each node 700 aggregates and deaggregates aggregation packets as they are communicated through the network. A plurality of aggregation packets 702₁, 702₂, . . . 702ₙ are communicated between each node 700. For each flow i, j, the uncompressed header of the first packet in the flow is required.

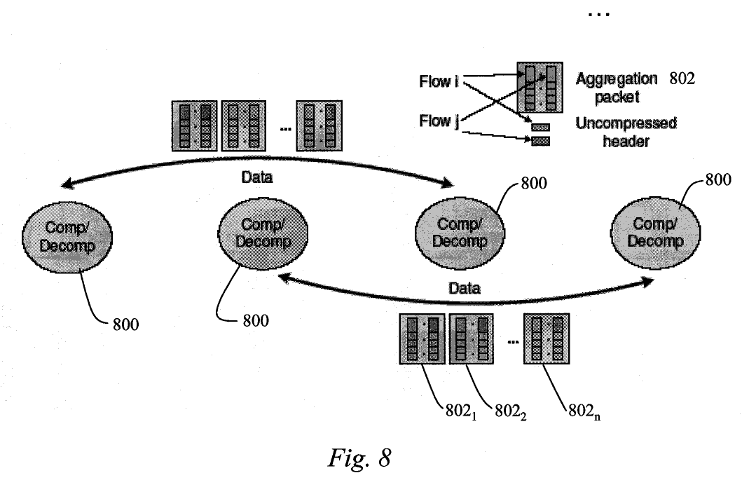

FIG. 8 is a flow diagram of ZLHC with accretion aggregation as described above at nodes 800 in a mesh network. Here, aggregation/deaggregation is not implemented at every intermediate node in the network, which relaxes hardware resource requirements on the routers at the mesh nodes 800. A plurality of aggregation packets 802₁, 802₂, . . . 802ₙ are communicated between nodes 800 that are the next hop or the destination for the aggregated packets as described above. Any intermediate node that does not implement aggregation/deaggregation in accordance with the accretion aggregation methodology merely forwards the aggregated packets to the next hop or destination.

The use of ZLHC provides the benefit of “robust to error propagation.” A corrupted packet cannot be decompressed and has to be dropped. Such a packet's failure to be decompressed could cause the compressor to drop subsequent packets received by the decompressor even though such packets were transmitted properly. Since ZLHC transfers only one uncompressed header for the same flow of packets in an aggregation packet, the uncompressed header allows the decompressor to restore the original headers by exploiting packet field redundancy. Thus, there is no influence from previous aggregation packets on uncompressing headers in a current aggregation packet.

ZLHC enables higher throughput by eliminating the dependency of round-trip acknowledgment. ZLHC does not require the use of context information to compress and decompress headers, thereby eliminating the need for feedback information to synchronize the compressor and decompressor.

ZLHC provides fault tolerance. There is no need to exchange status information for compression/decompression within the network, which is beneficial where there are frequent routing changes or node failures.

ZLHC can be utilized for multi-hop communications where aggregation packets are forwarded through intermediate nodes in accordance with the aggregation scheme disclosed herein. The lack of the need to compress and decompress aggregation packets at each node relaxes resource requirements.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. In a mesh network comprising a plurality of nodes, each node having a client interface and a backhaul interface for communicating between the nodes, a method for aggregating a plurality of packets, comprising:
at an ingress node that receives packets from at least one client, introducing a forced delay prior to aggregating packets at the ingress node;
at least one intermediate node communicating with the ingress node, forwarding aggregated packets received from the ingress node to a destination node.

2. The method of claim 1, further comprising the step of setting a minimum number of packets to be aggregated at the ingress node.

3. The method of claim 2, further comprising the step of setting a timer specifying a maximum time to wait to aggregate the packets at the ingress node.

4. The method of claim 3, further comprising upon expiration of the timer, aggregating packets from all flows to the ingress node having the same destination node until a size of the aggregated packets reaches the maximum transmission unit (MTU), and then sending the aggregated packets to the destination node via the at least one intermediate node.

5. The method of claim 3, further comprising upon expiration of the timer, aggregating packets from all flows to the ingress node having a same next hop intermediate node until a size of the aggregated packets reaches the maximum transmission unit (MTU), and then sending the aggregated packets to the next hop intermediate node.

6. In a mesh network comprising a plurality of nodes, each node having a client interface and a backhaul interface for communicating between the nodes, and a machine readable medium containing machine readable instructions which, when executed by a processor, enable:
an ingress node that receives packets from at least one client to introduce a forced delay prior to aggregating packets at the ingress node; and
at least one intermediate node communicating with the ingress node to forward aggregated packets received from the ingress node to a destination node.

7. The nodes of claim 6, wherein a minimum number of packets are to be aggregated at the ingress node.

8. The nodes of claim 7, wherein a maximum time to wait to aggregate the packets is set at the ingress node.

9. The nodes of claim 8, wherein the machine readable medium containing machine readable instructions which, when executed by the processor, upon expiration of the timer, enable the ingress node to aggregate packets from all flows to the ingress node having the same destination node until a size of the aggregated packets reaches the maximum transmission unit (MTU), and then send the aggregated packets to the destination node via the at least one intermediate node.

10. The nodes of claim 8, wherein the machine readable medium containing machine readable instructions which, when executed by the processor, upon expiration of the timer, enable the ingress node to aggregate packets from all flows to the ingress node having a same next hop intermediate node until a size of the aggregated packets reaches the maximum transmission unit (MTU), and then send the aggregated packets to the next hop intermediate node.

11. A method for compressing and decompressing packet headers of a plurality of packets in a mesh network including a plurality of nodes, comprising:
aggregating a plurality of packets in a flow into aggregated packets at a first node in the mesh network;
extracting the uncompressed header of a first packet in the flow;
compressing the aggregated packets at the first node;
deaggregating the aggregated packets at a second node in the mesh network; and
decompressing the aggregated packets with the uncompressed header of the first packet in the flow at a second node in the mesh network.
